(19) United States
(12) Patent Application Publication
(10) Pub. No.: US 2023/0184374 A1
(43) Pub. Date: Jun. 15, 2023

(54) CONNECTOR

(71) Applicant: SPARTAN BOSS LTD, Sussex (GB)

(72) Inventor: Robert GEARING, Withyham, Hartfield (GB)

(21) Appl. No.: 17/924,213

(22) PCT Filed: May 5, 2021
(86) PCT No.: PCT/IB2021/053797

§ 371 Date: Nov. 9, 2022

(30) Foreign Application Priority Data
May 29, 2020 (GB) 2008102.2
Oct. 21, 2020 (GB) 2016725.0

(51) Int. Cl. F16M 13/02; F41A 23/00; F16M 11/08; F16M 11/04; F16M 11/10; F16M 11/14

(52) U.S. Cl. CPC F16M 13/02; F41A 23/005; F16M 11/08; F16M 11/041; F16M 11/10; F16M 11/14; F41A 23/08

(57) ABSTRACT

This invention relates generally to the field of sporting and leisure activities such as hunting, cycling, and photography. A connector (10) for detachably connecting an object (12) to an article of equipment (14), the connector comprising a base (16) fittable on or to the article of equipment, or integral with the article of equipment, the base including one of a recess and an elongate projection, and the object including the other of a recess and an elongate projection, the connector further including slidable locking means (28) which slides transversely to and engages with the projection when the projection is inserted in the recess, to securely retain the projection within the recess until the slidable locking means is operated by a user to permit removal of the projection from the recess. One of the recess and projection may include cooperating magnetic means which encourages engagement of the projection within the recess.

### FIELD OF INVENTION

This invention relates generally to the field of sporting and leisure equipment, and particular, though not exclusively, equipment used in relation to outdoor activities such as hunting, cycling, and photography.

### BACKGROUND

In many leisure activities there is a need to be able to rapidly and securely connect different items of equipment together. For example, in photography it is useful to be able to connect a camera rapidly and securely to a tripod before using the camera on the tripod, and then to be able to detach the camera if the support of the tripod is no longer needed. In hunting, it is useful to be able to connect a bipod rapidly and securely to a hunting rifle so that the rifle can be stably supported by the bipod. GB2509988A discloses a magnetic camera mount which is designed to disengage in the event of a crash. Similarly, U.S. Pat. No. 9,268,201 discloses a break-away camera mount comprising a support for supporting a camera case steadily above a surfboard, first and second magnetic connectors each configured to magnetically engage each other, but which permit detachment upon sufficient shear and/or transverse force being applied to the mount. EP2880352 discloses a bipod for attachment to a corresponding fixture mounted on an article of equipment such as rifle, by means of magnetic attachment. The bipod can be readily detached from the rifle by a user firmly grasping the bipod and pulling it to overcome the magnetic attraction. In some situations, there is a need for a more secure connection to be established between an object and an article of sporting or leisure equipment, that nevertheless permits detachment of the object when desired by a user. EP1160499 discloses a camera-to tripod quick-release mounting including a pair of user actuated locking buttons which have to be depressed to permit a camera to connect to the mounting. The mechanism is fairly complicated with several ball/spring combinations. EP3282165 discloses a quick connection structure for photographic apparatus. The quick connection structure includes a vertically slidable sleeve (in the sense of its normal orientation) which moves against a strong vertically mounted compression spring to disengage a locking mechanism. WO2014/124669 discloses a bipod bracket-based mount for a firearm including locking means which is operated by depressing a button from one side (i.e., across the longitudinal axis of the firearm) to release the locking mechanism. This may involve a user holding the fiream outside a normal operation position. Magnets are provided to retain the locking mechanism in a locked condition to retain a firearm-engaging connection bracket within the locking mechanism.

### SUMMARY OF THE INVENTION

According to one aspect of the invention there is provided a connector for detachably connecting an object to an article of equipment, the connector comprising a base which is fittable on or to the article of equipment, or formed integral therewith, the base including one of a recess and a projection, and the object including, or being connected to, the other of a recess and a projection, the connector further including slidable locking means which engages with such a projection when the projection is inserted in the recess, and/or when the projection is rotated with respect to the recess, to securely retain the projection within the recess until the locking means is operated by a user to permit removal of the projection from the recess.

Preferably, the slidable locking means engages with the projection when the projection is inserted in the recess. Preferably, the slidable locking means moves transversely to the main longitudinal axis of the projection. More preferably, the slidable locking means moves perpendicularly to the main longitudinal axis of the projection.

The slidable locking means may include a user-grippable element. Preferably, the user-grippable element can be gripped between the forefinger and thumb of an average user. More preferably, the element can be slid by a user to disengage the locking means i.e., to allow release of the object. In a preferred embodiment, the slidable locking means may be operated by a user, who grips a slidable user-grippable element to disengage the locking means, whilst holding the article of equipment with their other hand. Most preferably, the slidable user-grippable element is slid away from the user in a generally horizontal direction/or, most preferably, parallel with a longitudinal axis of the article from the user to disengage the locking means. Most preferably, the user is able to retain normal operational control of the article of equipment which may be important for reasons including safety. For example, where the article of equipment is a firearm, the slidable user-grippable element is slid away in a generally horizontal direction parallel with the main longitudinal axis of the firearm to disengage the locking means, whilst the user still maintains a normal operational position in relation to the firearm and also retains control of the firearm. Such horizontal/parallel movement is convenient for user operation in that the user can maintain a normal operational position in relation to/control of the firearm. More specifically, a user can operate the sliddable user-grippable element with the fingers and thumb of one hand, whilst holding the trigger area of the firearm with their other hand. In another example, where the article is a motorcycle having handlebars, and the connector is used for attaching an object to those handlebars, then the slidable user-grippable element is slid away in a generally horizontal direction/or parallel with a longitudinal axis of the handlebars away from the rider on the motorcycle to disengage the locking means. Such horizontal/parallel movement is convenient for user operation in that the user can maintain a normal operational position in relation to/control of the motorcycle. The user-grippable sliding element, is preferably in the form of a slidable barrel. Such a barrel form provides a neat, simple appearance and avoids the need for projecting depressible button(s) or the like which can get caught e.g., on a user's clothing.

Typically, the projection is elongate, and generally cylindrical. Preferably, the recess is generally cylindrical having a longitudinal axis. One of the projection and/or recess may have surface features which engage with correspondingly shaped features or elements of the other of the projection and/or recess and/or locking means. The surface features are preferably grooves, or other recesses, provided by the projection, but could be grooves or other recesses provided by the base.

The projection may be freely inserted into the recess when the projection is in one axial orientation. Preferably, the projection may also be removed from the recess when the projection is the same axial orientation. When the projection is rotated into another axial orientation, termed, for example, a retained axial orientation, it may operate the locking means to prevent removal of the projection from the recess. For example, rotation of the projection may lead to a feature of the projection engaging with the locking means to prevent removal of the projection from the recess.

The slidable locking means may be urged into a locked condition by a biasing element. For example, the biasing element may be a compression spring or similar resilient element. In such a case, the biasing element may be compressed by a user to move the locking means into an unlocked condition permitting removal of the projection by the user. When the user no longer compresses the biasing element, the locking means returns to a locked condition under the influence of the spring or similar resilient element in which the projection cannot be readily removed from the recess. In the locked condition, an element of the locking means may cooperate with an element or feature on the projection to retain the projection within the recess.

The projection may be retained in at least one axial orientation by a detent. In this way, the object can be retained in a number of different axial orientations with respect to the article. The detent may be a ball detent which cooperates with a correspondingly sized longitudinal groove in the projection (e.g., formed by a wall of the projection) to retain the projection in a particular axial orientation. The projection may define more than one such longitudinal groove which each permit the projection to be retained in more than one axial orientation. The projection may define a further wider groove which permits axial rotation of the inserted projection until the detent contacts either side of the groove.

Preferably, the base for fitting on, or formed integral with, the article of equipment includes the recess, and the object includes the corresponding projection, or is connected to an element forming the projection. This is preferred because the base and/or the article can have a smoother outline, which is preferable in many leisure applications such as hunting.

According to another aspect of the invention there is provided a connector for detachably connecting an object to an article of equipment, the connector comprising a base fittable on or to the article of equipment, or integral therewith, the base including one of a recess and a projection, and the object including, or being connected to, the other of a recess and a projection, the connector further including slidable locking means which engages with such a projection when the projection is inserted in the recess, and/or when the projection is rotated with respect to the recess, to securely retain the projection within the recess until the locking means is operated by a user to permit removal of the projection from the recess, and in which at least one of the recess and projection includes cooperating magnetic means which encourages engagement of the projection within the recess i.e. the projection is encouraged into the recess.

The connector of this aspect of the invention is advantageous in that, due to the magnetic retention of the spigot, the object is not disconnected from the connector in the event that the locking means is moved to an unlocked condition. It will be appreciated by the skilled addressee, that such removal of the projection is against the magnetic means which encourages retention of the projection within the recess. Furthermore, magnetic attraction may assist insertion of the projection into the recess.

The magnetic means may comprise a magnet and a corresponding ferrous element which is attracted by the magnet. Alternatively, the magnetic means may comprise separate magnets having opposed opposite (i.e., North and South) poles. Preferably the magnetic means includes at least one rare earth magnet, such as a neodymium magnet (also known as NdFeB, NIB or Neo magnet) due to the combination of magnetic strength and compact size that such magnets possess. However, other such rare earth magnets such as samarium cobalt are contemplated for use in the invention. In a preferred embodiment, the projection includes a magnet, and the base includes a magnet of opposite polarity, or the base may be ferrous.

Other features of the connector according to this aspect of the invention may be otherwise generally as described in relation to the first aspect of the invention.

In some embodiments according either aspect of the invention, at least one element of the connector is provided by one or both of the article of equipment and object. For example, where the article is a rifle and the object is a bipod, then the projection may be provided by the bipod head. In other embodiments the connector may be separate of the article of equipment and object.

According to another aspect of the invention there is provided a combination comprising a connector in accordance with the invention and an object and/or an article of equipment.

The skilled addressee will appreciate that the article of equipment is not limiting to the invention. For example, the article of equipment could be a rifle or other firearm, a camera, a bicycle or motorcycle, or a helmet. Where the article of equipment is a rifle or other firearm, the object could be a bipod, tripod, monopod or other support, or a lamp, or laser range finder, or night vision illuminator. Where the article of equipment is a camera, the object could be, for example, a support such as a tripod or monopod. Where the article of equipment is a bicycle or motorcycle having handlebars, the object could be, for example, a navigation device such as a GPS unit, a camera, or a mobile phone for connecting to the handlebars. Where the article of equipment is a helmet, the object could be, for example, a camera. The reference to leisure use in the specification is not limiting and embraces objects and articles for amateur and professional use.

### BRIEF DESCRIPTION OF THE DRAWINGS

A connector in accordance with the invention will now be described, by way of example only, with reference to the accompanying drawings, FIGS. 1 to 7, in which:

FIG. 1 is a detail elevation view from one side showing a connector in accordance with the invention connecting a bipod to a rifle;

FIG. 2 is a detail elevation including a longitudinal cross section through the connector of FIG. 1 from the other side to that shown in FIG. 1;

FIG. 3A is an elevation of a portion of the connector of FIG. 1 from one side;

FIG. 3B is an elevation of the portion of the connector of FIG. 1 from the opposite side to FIG. 3A;

FIG. 4 is a plan view of the portion of the connector of FIG. 3A and 3B;

FIG. 5 is a perspective from below and one side of a component of the connector of FIG. 1;

FIG. 6 is a perspective view of another connector in accordance with the invention for use in connecting a device such as a camera to a ball head tripod; and

FIG. 7 is a vertical cross section through the connector of FIG. 6 along line B-B.

### DESCRIPTION

Connector for Connecting a Firearm to a Bipod

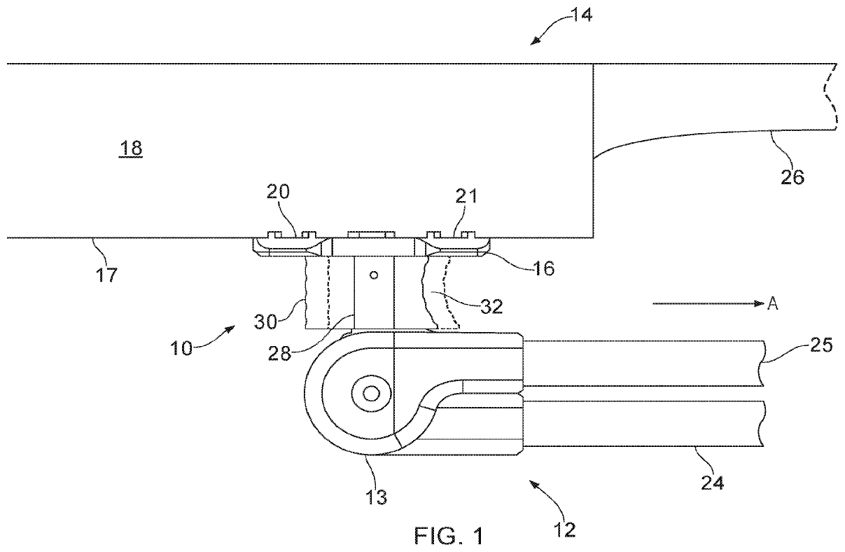

A connector 10 in accordance with the invention is shown in FIG. 1, connecting a bipod 12 (an example of an object in the context of the invention) to a hunting rifle 14 (an example of an article of equipment in the context of the invention). A tripod could be used as the object instead of a bipod. The connector 10 includes a steel base 16 component which is fixed to the lower surface 17 of the wooden fore-end 18 of the rifle 14 by screws (omitted for clarity) which pass through holes 20, 21 in the base 16 into the fore-end. For military rifles and other firearms having an accessory mounting system on the fore-end such as, for example, a Picatinny, STANAG 4694 NATO accessory rail, Weaver rail or similar, the base 16 of the connector base may be fixed to the accessory mounting system, by clamping, bolting or as otherwise appropriate to the system, rather than directly to the material of the fore-end. In other cases, the connector base is formed integral with the article.

It will be noted that the legs 24, 25 of the bipod 12 extend forwardly, from a bipod head joint 13, which hingedly connects the legs 24, 25 under the barrel 26 of the rifle in the folded configuration shown in FIG. 1.

The connector 10 further comprises an aluminium locking slide 28 having a substantially flat rear face 30 and a curved forward face 32. The locking slide 28 is substantially in the form of a barrel. The locking slide 28 is shown in a rearward locking position in FIG. 1. The locking slide can be slid in the direction of arrow A (i.e parallel with the main longitudinal access of the firearm) by a user into a forward unlocked, or disengaged, position (shown in dotted outline in FIG. 1) by user pressure on the rear face 30. Typically, a user may press with their thumb on the rear face 30 to move the locking slide 28 forward to allow normal engagement or disengagement of the bipod. An average righthanded user using the connector 10 in conjunction with an article of equipment such as a firearm may conveniently grip the locking slide between the thumb and forefinger of their left hand and push the locking slide forward whilst holding the firearm with their right hand, i.e., whilst still maintaining control of the firearm.

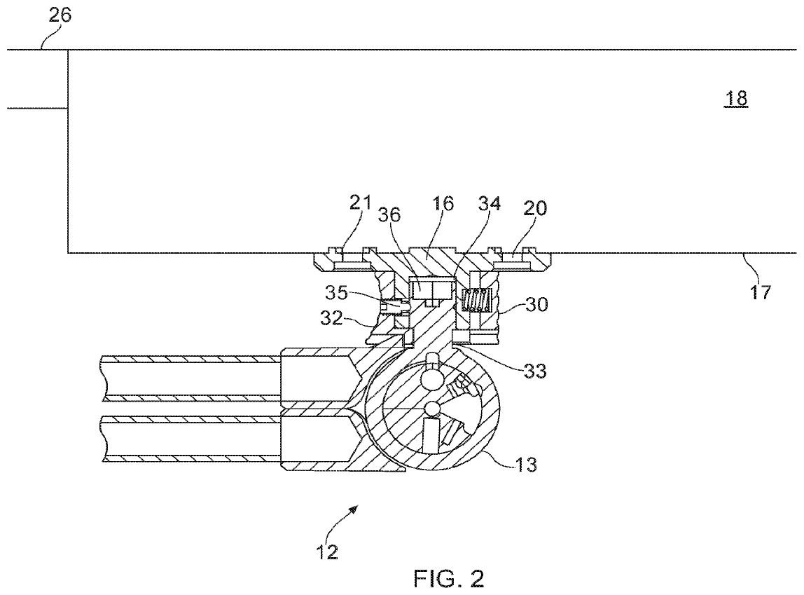

The connector 10 is shown in cross-section in FIG. 2. It can be seen that the bipod head joint 13 includes an integral projection 33 (forming the projection in the context of the invention) which is received within a generally cylindrical recess 34 defined by the base 16. The projection 33, which is generally cylindrical, optionally includes a rare earth magnet 44 fixed to the upper end of the projection. The magnet 44 may be glued in position or otherwise held, for example, by a screw passing through an aperture in the magnet 44 into the projection 33. It will be appreciated that the magnet 44 can be omitted from the connector in some embodiments.

A ball detent 35 is located in a forward portion of the locking slide 28 and extends through an aperture in the forward wall of the recesses 34, where it bears against the outer surface of the projection 33, when the projection is inserted in the recess 34 and the locking slide is in the rearward locking position.

A spring 36 is located between the locking slide and a portion of the base 16 forming the rear of the recess 34 so that the spring is compressed when the rear face 30 is pressed by a user moving the locking slide 28 into the forward unlocked position.

When the locking slide is so moved into the forward unlocking position, the ball detent 35 is moved away from the surface of the projection 33.

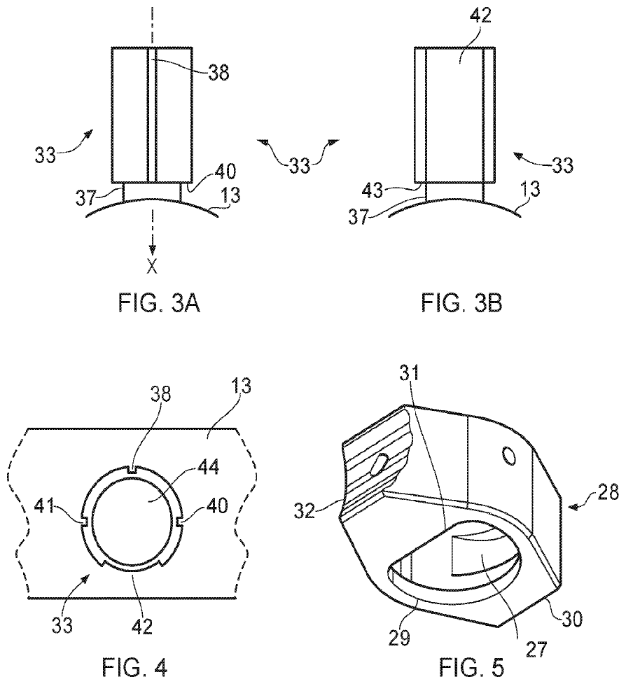

The generally cylindrical profile of the projection 33, around a longitudinal axis X (shown in FIG. 3A) extending via a narrower cylindrical neck 37 from the bipod joint 13 is shown in more detail in FIG. 3A and FIG. 3B and FIG. 4. The projection 33 is shown in FIG. 3A in elevation when the orientation of the bipod is in the position shown in FIG. 2. A narrow vertical groove 38 extends vertically on the facing surface of the projection 33 for receiving the ball detent. As shown in the plan view of FIG. 4 two more further narrow vertical grooves 40, 41 are formed in the surface of the projection 33 at 90 degrees of rotation about the axis X from the narrow groove 38. A wider groove 42 is formed on the opposite surface of the projection 33. The lower edge of the projection 33 and the narrower neck 37 form a rim 43.

The locking slide 28 is shown in more detail in FIG. 5, which shows it isolated from the other elements of the connector 10 for clarity. The locking slide 28 forms a generally D-shaped aperture 29, which has a substantially straight forward edge 31. A rear aperture 27 receives the spring 36.

The locking slide 28 moves generally horizontally, transversely to the longitudinal axis X of the projection, parallel with the main longitudinal axis of the firearm. More particularly, the locking slide moves perpendicularly to the projection.

In use, a user generally has to move the locking slide 28 of the connector 10 to the forward unlocked position against the action of the spring 36 before the projection 33 can be inserted into the recess 34. An exception to this is when the wider groove 42 on one side of the projection 33 is aligned with the front of the recess 34. In that axial orientation the wider groove 42 is aligned with the straight front edge 31 of the locking slide 28, and the projection 33 can be inserted into the recess without the locking slide being activated. In either case, the magnet 44 (where present) is attracted to the steel base 16, which facilitates insertion of the projection 33 into the recess 34 and inhibits the bipod from being accidentally detached from the connector. Release of the locking slide 28 by user allows the locking slide 28 to move rearwardly under the action of the spring 36, so that the lower forward edge of the slide, around the edge 31, engages under the forward edge of the rim 43 holding the projection and connected bipod 12 securely to the rifle. Therefore, in order to remove the bipod from the connected rifle, a user has to move the locking slide forwardly into the unlocked position so that the lower edge of the slide 28 no longer engages the forward edge of the rim 43. The projection can then be removed from the recess 34 by pulling to overcome the attraction between the magnet 44 (where present) and the ferrous base 16. The only exception is in the above situation is where the wider longitudinal groove 42 is aligned with the front of the recess 34. In that axial orientation the wider groove 42 is aligned with the straight front edge 31 of the locking slide 28, and the projection 33 can be withdrawn from the recess, when the attraction between the magnet 44 and the base 16 is overcome (where the magnet is present) without the locking slide 28 being activated. This provides an advantageous quick detachment orientation/facility.

The connector 10 allows the connected bipod 12 to rotate freely about the longitudinal axis of the projection through 360 degrees. The ball detent 35 holds the projection in different axial orientations through engagement with the grooves. Engagement of the ball detent with the opposed narrow grooves 40, and 41 holds the bipod in the forward-pointing folded condition shown in FIGS. 1 to 3, or, as the case may be, a rearward-pointing folded condition in which the legs 24, 25 extend rearwardly depending on the groove 40, 41 engaged by the ball detent. When the ball detent is in the narrow groove 38, and the bipod joint is operated so that the legs 24, 25 are moved to a downwardly depending and splayed active position the rifle is held in a generally forward-facing position and the bipod does not freely rotate. This is advantageous in a target shooting situation, where a rifle does not need to be panned. Alternatively, when the ball detent is in the wide groove 41, the projection is free to rotate between the extremes of engagement of the ball detent with either side of the wide groove 42. In this manner, when the legs 24, 25 are in a downwardly depending and splayed active position the rifle can be panned between the limits imposed by the engagement of the ball detent with the vertical edges of the wide groove 42, whilst still being supported by the bipod. This is advantageous in a hunting situation. It should be noted that the ball detent 35 permits rotation of the projection through 360 degrees when overcome by a user.

From the above it can be seen that the bipod 12 can be quickly connected to the rifle 14 by inserting the projection 33 into the recess 34 formed by the base, either by aligning the wider groove 42 with the straight front edge 31 of the locking slide 28 so that the projection 33 can be passed though into the recess 34, or by retracting the locking slide 28 so that the projection 33 can be inserted into the recess 34 in any axial orientation. Once the projection is inserted into the recess it can be rotated about its longitudinal axis which engages the locking slide 28 with the rim 43 of the projection but permits further rotation of the bipod into different axial orientations. The bipod is thus held securely by the connector in the normal downwardly depending legs active position, typically used when shooting the rifle, and can only be detached from the rifle by operating the locking slide 28. Furthermore, the bipod is securely held by the connector 10 when the legs of the bipod are in either a forward-pointing or a rearward-pointing folded position, typically used when the rifle 14 is being carried by a user and cannot be removed from the rifle without operating the locking slide. The ball detent retains the bipod in the different axial orientations.

Connector for Connecting an Optical Device to a Tripod

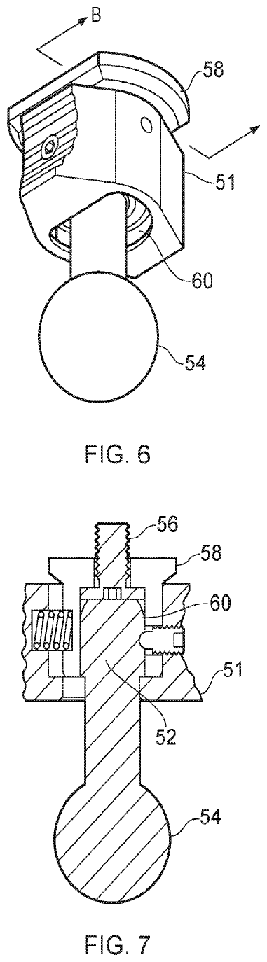

By way of example of another article of equipment, an optical device such as a camera may be connected to a tripod by such a connector as described above with simple changes. One such connector 50 for an optical device is shown in FIGS. 6 and 7. The connector 50 is formed generally as described above in relation to connector 10, with a slidable aluminium locking slide 51, which can be moved against resilient biassing means provided by a spring as described above. In use, the connector recess 60 receives a projection 52 which is integral with a ball head 54 for a conventional ball tripod (not shown). A steel bolt 56 extends through steel base 58 for fitting to the screw mount on the base of a camera or large telephoto lens. Most consumer cameras are fitted with 1/4-20 UNC threads. Typically, professional cameras and lenses may be fitted with 3/8-16 UNC threads. The bolt 56 is correspondingly threaded to match the screw mount according to the intended use. In this way, the connector 50 can be firmly attached to the screw mount on the base of a camera by means of the bolt 56. The connected camera and connector can be rapidly and securely connected to the projection 52 on a ball head tripod (not shown) by operating the locking slide 51 or pushing the projection 52 into the recess so that it operates the slide 51. A ball detent engages a corresponding depression defined by the surface of the projection. The projection 52 can be released from the connector 50 by operating the slide 51. One of the projection or the bolt may be provided with a magnet to facilitate connection of the projection to the connector. It will be noted that a user standing normally behind a tripod to use the camera will push the slide 51 generally horizontally to release the projection unless the projection is in an axial orientation which permits removal of the projection without operation of the locking means. This is convenient to do in practice as the user is in the same stance for operation of the connector slide as for operation of the camera.

Connection of a Phone to a Bicycle

By way of example of another article of equipment, a mobile phone may be connected to a bicycle or motorbike, by such a connector as described above with simple changes. The base of the connector having the recess could be provided in the form of an adaptor fitted to the mobile phone which receives a similar projection provided by, or in the form of a further adaptor fitted to, the bicycle stem or handlebars. The slidable locking slide can be moved by the user in a direction generally parallel with the main longitudinal axis of the handlebars or stem to release the projection (and the connected phone) from the recess.

1. A connector for detachably connecting an object to an article of equipment, the connector comprising:
a base which is fittable on or to the article of equipment, or formed integral with the article of equipment, the base including one of a recess and an elongate projection having a longitudinal axis, and the object including, or being connected to an element which provides, the other of a recess and an elongate projection having a longitudinal axis, and
slidable locking means which engage with the projection when the projection is inserted in the recess, to securely retain the projection within the recess until the slidable locking means is operated by a user to permit removal of the projection from the recess, in which the slidable locking means is moved generally transversely to the longitudinal axis of the projection, and along or generally parallel with a main longitudinal axis of the article of equipment.

2. The connector according to claim 1, wherein the projection is freely axially rotatable about the longitudinal axis of the projection into different axial orientations with respect to the recess, when inserted in the recess.

3. The connector according to claim 1, wherein the slidable locking means can be moved between a locked position and an unlocked position, by sliding generally transversely, to a main longitudinal axis of the projection.

4. The connector according to claim 1, wherein the projection can be inserted into the recess in at least one axial orientation without actuating the locking means.

5. The connector according to claim 4, wherein the projection can be removed axially from the recess in at least one axial orientation without actuating or operating the locking means.

6. The connector according to claim 5, wherein the projection can be inserted into, or removed from the recess, in the same axial orientation without actuating the locking means.

7. The connector according to claim 1, wherein the projection is retained in at least one axial orientation with respect to the longitudinal axis of the projection by a detent.

8. The connector according to claim 7, wherein the detent is a ball detent which cooperates with a relatively narrow longitudinal groove in the projection to retain the projection in a particular axial orientation.

9. The connector according to claim 8, wherein the projection defines more than one such longitudinal groove, each of which grooves permit the projection to be retained in more than one axial orientation by engagement of the respective groove with the ball detent.

10. The connector according to claim 8, wherein the projection defines a relatively wider longitudinal groove which permits axial rotation of the projection until the detent contacts either side of the wider groove.

11. The connector according to claim 1, wherein slidable locking means is biased into a locked position.

12. The connector according to claim 11, wherein the the slidable locking means is biased by a spring or other resilient means.

13. The connector according to claim 1, wherein the recess is defined by the base.

14. The connector according to claim 13, wherein the projection is provided by the object or an element connected to the object.

15. The connector according to claim 1, wherein at least one of the recess and projection includes cooperating magnetic means which encourages engagement of the projection within the recess,

16. The connector according to claim 15, wherein the projection includes or supports a magnet.

17. The connector according to claim 16, wherein the base and/or recess is ferrous.

18. The connector according to claim 1, wherein the slidable locking means can be operated by a user whilst maintaining control of, or adopting a normal operating stance in relation to, the article of equipment.

19. A combination comprising the connector according to claim 1 and an article of equipment.

20. The combination according to claim 19, wherein the article of equipment is one of a firearm, a bicycle, a motorbike, a camera, or a mobile phone.

21. The combination according to claim 20, wherein the article of equipment is a firearm, and a connected object is a bipod or tripod.

22. The combination according to claim 20, wherein the connected bipod or tripod can be freely rotated into different axial orientations, and the slidable locking means can be operated by a user to release the connected bipod or tripod by sliding the slidable locking means with one hand generally parallel with the main longitudinal axis of the firearm whilst maintaining control of the firearm with the user's other hand.

23. The combination according to claim 21, in which the projection can be axially rotated into a specific axial orientation in which orientation, the bipod or tripod can be conveniently removed from the firearm without operating the slidable locking means.

24. The combination according to claim 23, wherein in other axial orientations, the bipod or tripod is securely retained by the slidable locking means, and where a magnet is present, by magnetic attraction between the projection and the base or recess of the connector.
